(19) United States
(12) Patent Application Publication
(10) Pub. No.: US 2020/0074529 A1
(43) Pub. Date: Mar. 5, 2020

(54) COMPONENT ORDERING DEVICE AND COMPONENT ORDERING METHOD

(71) Applicant: HITACHI, LTD., Tokyo (JP)

(72) Inventors: Yuma SHIHO, Tokyo (JP); Masataka TANAKA, Tokyo (JP); Tomoyuki KASAHARA, Tokyo (JP); Yoshinori KONUMA, Tokyo (JP); Takehito KAWAKAMI, Tokyo (JP)

(21) Appl. No.: 16/507,098

(22) Filed: Jul. 10, 2019

(30) Foreign Application Priority Data
Sep. 4, 2018 (JP) 2018-165121

(51) Int. Cl. G06Q 30/06; G06Q 30/02

(52) U.S. Cl. CPC G06Q 30/0633; G06Q 30/0631; G06Q 30/0283

(57) ABSTRACT

Provided is a component ordering device that estimates an order condition that is possible to be accepted by a supplier with higher accuracy. The component ordering device includes: an order condition proposal generation unit that generates a plurality of order condition proposals when negotiating with a supplier for a component to be procured, based on negotiation history information that is established by negotiating with the supplier in the past for another component belonging to the same component classification with the component to be procured, the negotiation history information including an order condition provided with a lot size and a unit price; and an output control unit that outputs the plurality of order condition proposals.

### CROSS-REFERENCE TO RELATED APPLICATION

The present application claims priority from Japanese application JP 2018-165121, filed on Sep. 4, 2018, the contents of which is hereby incorporated by reference into this application.

### TECHNICAL FIELD

The present invention relates to a component ordering device and a component ordering method.

### BACKGROUND ART

When a manufacturer of a product procures a component for producing a product from a supplier, an order condition that includes a unit price and a lot size indicating a minimum quantity to be procured in a single order is negotiated in advance with the supplier. At this time, the component is excessively purchased when the lot size is large according to a demand of the component, leading to an increase in both purchase cost and stock management cost. However, in general, the unit price tends to decrease because productive efficiency is improved for the supplier when the lot size is increased.

Therefore, it is important to determine the order condition in consideration of a balance between the purchase cost and the stock management cost in accordance with the demand of the component. In particular, in case of an individually ordered design product such as a control panel employed in social infrastructure, for which a product configuration suitable for an order of a customer is designed for each order and required component arrangement and ordering are performed to produce the product, it is important to periodically negotiate with the supplier for demand changes and to review the order condition since demand of the component largely changes according to production situation.

However, since negotiation with the supplier needs time, it is desirable for manufacturers that order a large number of components to estimate a cost reduction sum in advance in case where the order condition is changed for each component, to specify a component having a large cost reduction sum and to preferentially review (change) the order condition, before negotiating with the supplier. In order to estimate the cost reduction sum before negotiation, it is necessary to estimate what order condition (lot size, unit price) is possible to be accepted by the supplier.

Therefore, as a configuration for bidding and purchasing components in the related art, PTL 1 describes a system in which “a regression arithmetic processing unit 2-1 acquires main function information (rating) and the like for determining a price from a component information server 1-A for each type of component, and acquires information of price and quantity of a corresponding component and the like from a purchase information server 1-B (in some cases only price is acquired); correlation analysis such as multiple regression, single regression, or spline approximation is performed based on the data, and a correlation equation in which an optimal correlational relationship is obtained is calculated; a bid and purchase determination processing unit 2-2 determines which component is put on a bid based on the correlation equation; and a bid and purchase processing unit 3-1 electronically bids for or purchase the component based on the determination”.

### PRIOR ART LITERATURE

### Patent Literature

PTL 1: JP-A-2003-203175

### SUMMARY OF INVENTION

### Technical Problem

In the system described in PTL 1, correlation between the purchase quantity and the unit price when the component to be procured was purchased in the past is analyzed, so that one unit price for a random purchase quantity is estimated. However, since the unit price of the component is also influenced by production lot size of the supplier and the like, the order condition that is possible to be accepted by the supplier cannot be accurately estimated simply through the correlation analysis by the system described in PTL 1.

The invention has been made in view of such a situation. An object of the invention is to make it possible to estimate an order condition that is possible to be accepted by a supplier more accurately, and to specify a component to be preferentially negotiated with the supplier for a user.

### Solution to Problem

The present application includes a plurality of means for solving at least a part of the problems and an example thereof is as follows. In order to solve the problems, a component ordering device according to an aspect of the invention includes: an order condition proposal generation unit that generates a plurality of order condition proposals when negotiating with a supplier for a component to be procured, based on negotiation history information that is established by negotiating with the supplier in past for another component belonging to the same component classification with the component to be procured, the negotiation history information including an order condition provided with a lot size and a unit price; and an output control unit that outputs the plurality of generated order condition proposals.

### Advantageous Effect

According to the invention, an order condition that is possible to be accepted by a supplier can be estimated with higher accuracy, and a component to be preferentially negotiated between a user and the supplier can be specified.

Problems, configurations, and effects other than those described above will be clarified by descriptions of following embodiments.

### BRIEF DESCRIPTION OF DRAWINGS

FIG. 1 shows a configuration example of a component ordering system according to a first embodiment of the invention.

FIG. 2 shows an example of component master information.

FIG. 3 shows an example of negotiation history information.

FIG. 4 shows an example of component demand information.

FIG. 5 shows an example of component-based unit price change information.

FIG. 6 shows an example of classification-based unit price change information.

FIG. 7 shows an example of order condition proposal information.

FIG. 8 shows an example of cost information.

FIG. 9 shows an example of recommended order condition proposal information.

FIG. 10 shows an example of stock information.

FIG. 11 is a flowchart illustrating an example of an order condition recommendation processing.

FIG. 12 shows a display example of an input screen.

FIG. 13 is a flowchart illustrating processing of step S3 in detail.

FIGS. 14(A) to 14(C) illustrate the processing of step S3, in which FIG. 14(A) shows an example of intermediate information 2221, FIG. 14(B) shows an example of intermediate information 2222 and FIG. 14(C) shows an example of intermediate information 2223.

FIG. 15 is a flowchart illustrating processing of step S5 in detail.

FIGS. 16(A) to 16(C) illustrate the processing of step S5, in which FIG. 16(A) shows an example of intermediate information 2241, FIG. 16(B) shows an example of intermediate information 2242 and FIG. 16(C) shows an example of intermediate information 2243.

FIG. 17 shows a display example of an output screen.

FIG. 18 shows a configuration example of a component ordering system according to a second embodiment of the invention.

FIG. 19 shows an example of component classification master information.

FIG. 20 shows an example of classification granularity information.

FIG. 21 shows an example of negotiation history information.

FIG. 22 is a flowchart illustrating an example of an order condition recommendation processing.

FIG. 23 shows an example of major classification-based unit price change information.

FIG. 24 shows an example of minor classification-based unit price change information.

FIG. 25 is a flowchart illustrating processing of step S35 in detail.

FIGS. 26(A) and 26(B) illustrate the processing of step S35, in which FIG. 26(A) shows an example of intermediate information 2244 and FIG. 26(B) shows an example of intermediate information 2245.

FIG. 27 shows an example of classification-based unit price change information.

### DESCRIPTION OF EMBODIMENTS

Hereinafter, a plurality of embodiments of the invention will be described with reference to the drawings. In all the drawings for illustrating the embodiments, the same members are denoted by the same reference numerals in principle, and repetitive description thereof will be omitted. Further, in the following embodiments, it is needless to say that constituent elements (including element steps and the like) are not always indispensable unless otherwise stated or except the case where the constituent elements are apparently indispensable in principle. Further, it is needless to say that expressions “formed of A”, “made of A”, “having A”, and “including A” do not exclude elements other than A unless otherwise stated that A is the only element thereof. Similarly, in the following embodiments, when referring to shapes, positional relationships, and the like of the constituent elements and the like, shapes and the like which are substantially approximate or similar to those are included unless otherwise stated or except the case where it is conceivable that they are apparently excluded in principle.

<Configuration Example of Component Ordering System According to First Embodiment of Invention>

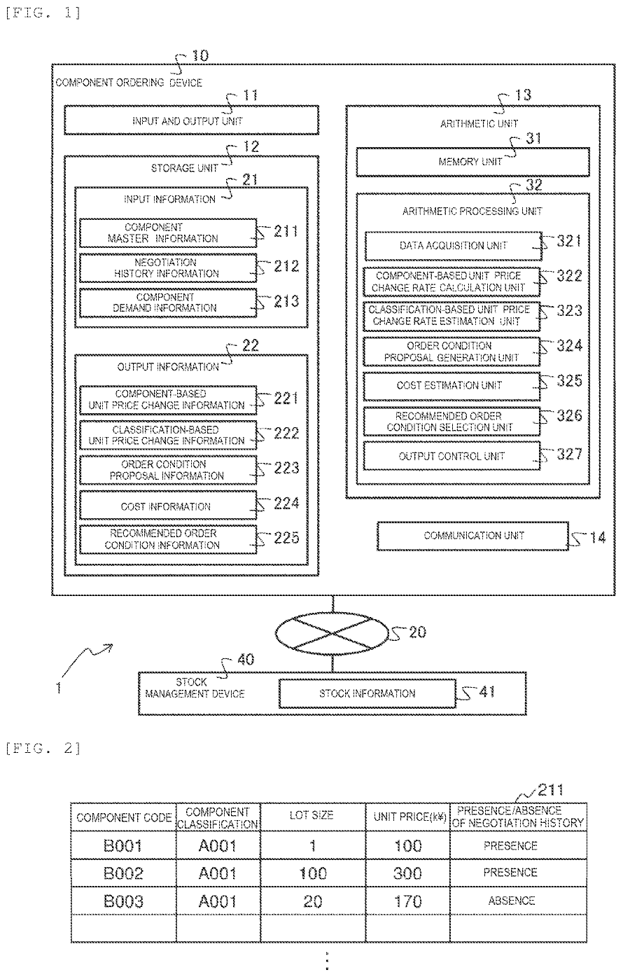

FIG. 1 shows a configuration example of a component ordering system 1 according to a first embodiment of the invention. The component ordering system 1 includes a component ordering device 10 and a stock management device 40.

The component ordering device 10 is realized by, for example, a personal computer. The component ordering device 10 includes an input and output unit 11, a storage unit 12, an arithmetic unit 13, and a communication unit 14.

The input and output unit 11 includes, for example, a keyboard, a mouse and a display. The input and output unit 11 receives information (to be described in detail below) necessary for various processing by the arithmetic unit 13 from a user and outputs the information to the storage unit 12. The input and output unit 11 displays information (to be described in detail below) obtained as a result of the various processing by the arithmetic unit 13 and presents the information to the user.

The storage unit 12 includes, for example, a Hard Disk Drive (HDD) and a Solid State Drive (SSD). The storage unit 12 stores the information necessary for the various processing by the arithmetic unit 13 as input information 21. The storage unit 12 also stores the information obtained as a result of the various processing by the arithmetic unit 13 as output information 22.

The input information 21 includes component master information 211, negotiation history information 212, and component demand information 213.

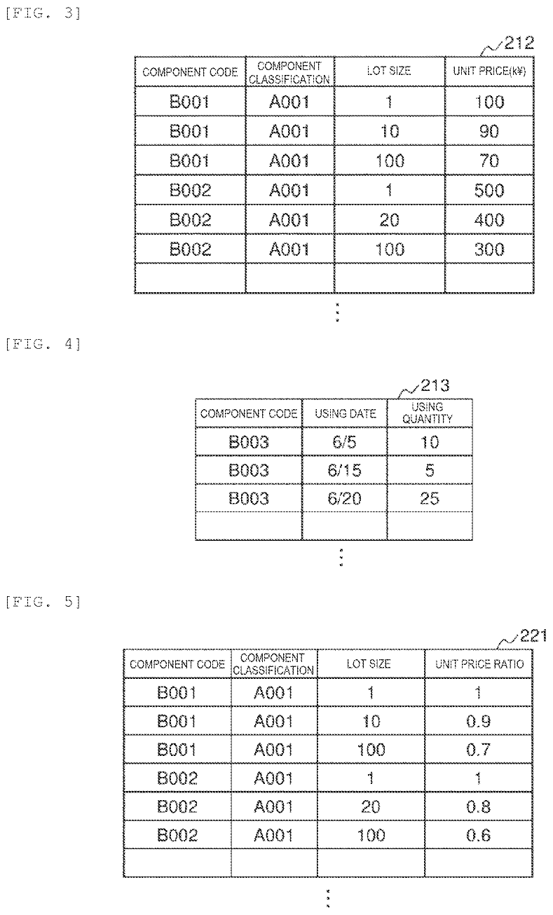

FIG. 2 shows an example of the component master information 211. The component master information 211 indicates the latest order condition established with a supplier. The component master information 211 records component codes that are identifiers of all components constituting a product, component classifications representing types of components, lot sizes and unit prices in the latest order condition, and presence or absence of a negotiation history. Here, a lot size is a minimum quantity that needs to be purchased in a single order. The presence or absence of a negotiation history is information indicating whether there is an established order condition by negotiating with a supplier in the past in addition to the latest order condition for the components.

In the case of FIG. 2, for example, it is shown that: a component code B001 belongs to a component classification A001; a latest order condition thereof indicates that a lot size is 1 and a unit price is 100 K¥; and an established order condition thereof by negotiating with a supplier in the past is present.

Other information regarding component ordering such as procurement lead time may be added to order conditions in the component master information 211.

Next, FIG. 3 shows an example of the negotiation history information 212. The negotiation history information 212 indicates contents of order information established with a supplier in the past for components whose presence or absence of negotiation history in the component master information 211 (FIG. 2) is determined to be “present”. The negotiation history information 212 includes component codes, component classifications, and lot sizes and unit prices in order conditions established in the past.

In the case of FIG. 3, for example, contents (a unit price of 100 K¥ at a lot size of 1, a unit price of 90 K¥ at a lot size of 10, and a unit price 70 K¥ at a lot size of 100) of three pieces of order information established in the past are recorded for the component code B001 belonging to the component classification A001.

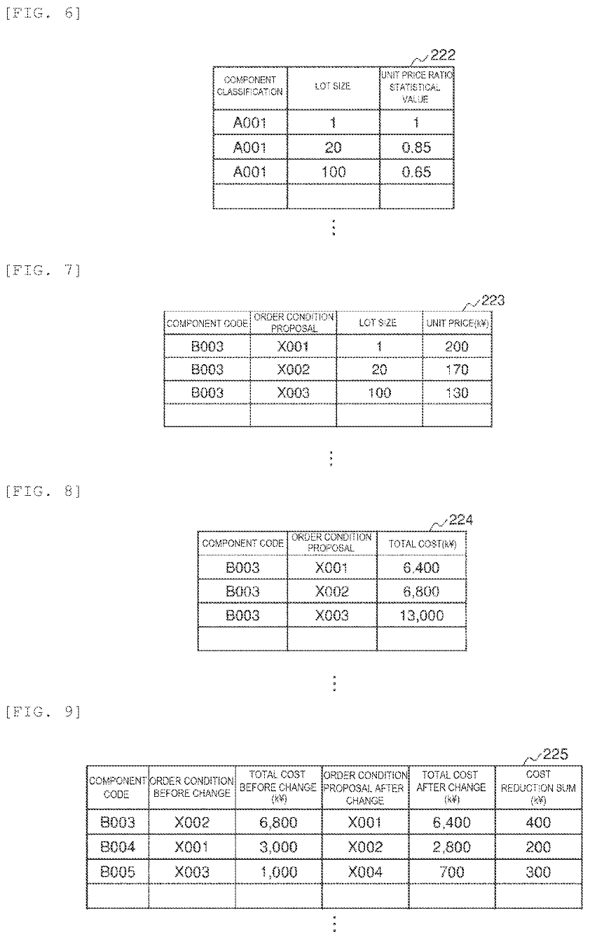

Next, FIG. 4 shows an example of the component demand information 213. The component demand information 213 is for managing daily using amount (demand amount) of each component. The component demand information 213 includes component codes, using dates, and using quantities.

In the case of FIG. 4, for example, it is shown that 10 are demanded on June 5, 5 are demanded on June 15 and 25 are demanded on June 20 for components of a component code B003.

Return to FIG. 1. The output information 22 includes component-based unit price change information 221, classification-based unit price change information 222, order condition proposal information 223, cost information 224, and recommended order condition information 225.

FIG. 5 shows an example of the component-based unit price change information 221. The component-based unit price change information 221 is for managing change rates of unit prices when lot sizes are changed, for the components whose presence or absence of the negotiation history in the component master information 211 (FIG. 2) is determined to be “present”.

The component-based unit price change information 221 includes component codes, component classifications, lot sizes, and unit price ratios. A unit price ratio represents a ratio of a unit price of another lot size to a unit price of a lot size of 1, with the unit price of the lot size of 1 taken as a reference value 1. In the case of FIG. 5, for example, it is shown that a unit price ratio is 0.9 when a lot size is 10 and a unit price ratio is 0.7 when a lot size is 100, among the order conditions established in the past for components of a component code B001.

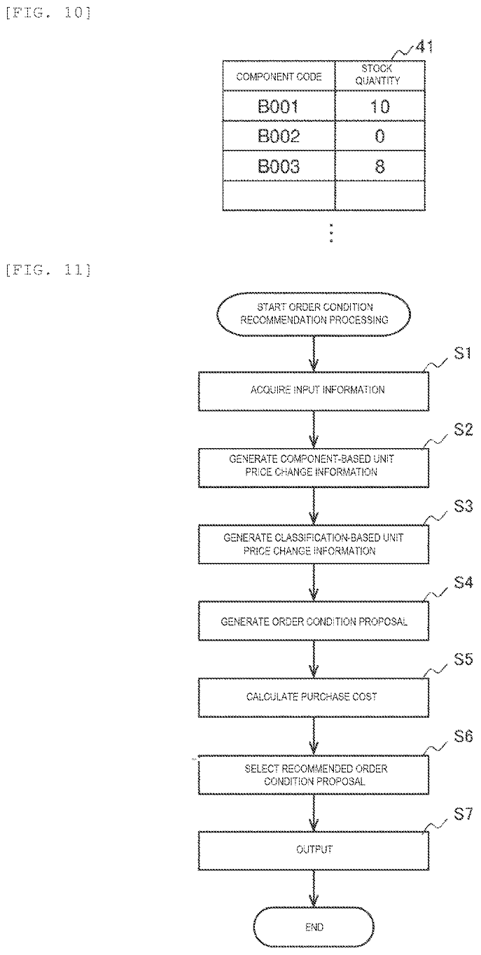

Next, FIG. 6 shows an example of the classification-based unit price change information 222. The classification-based unit price change information 222 is for managing change rates of unit prices estimated when lot sizes of components are changed for each component classification. The classification-based unit price change information 222 includes component classifications, lot sizes, and unit price ratio statistical values. A unit price ratio statistical value represents a statistical value (to be described in detail below) of unit price ratios of other lot sizes, with a unit price of a lot size of 1 taken as a reference value 1. In the case of FIG. 6, for example, it is shown that a unit price ratio statistical value is 0.85 when a lot size is 20, and a unit price ratio statistical value is 0.65 when a lot size is 100, for components belonging to a component classification A001.

Next, FIG. 7 shows an example of the order condition proposal information 223. The order condition proposal information 223 is for managing order condition proposals (including the latest order condition) which are alternatives to changed order conditions when a change of the order condition is negotiated with a supplier. The order condition proposal information 223 includes component codes, (codes of) order condition proposals, lot sizes, and unit prices.

FIG. 7 shows three order condition proposals for a component code B003. For example, an order condition X001 is a unit price of 200 k¥ at a lot size of 1, an order condition (the latest order condition) X002 is a unit price of 170 k¥ at a lot size of 20, and an order condition X003 is a unit price of 130 k¥ at a lot size of 100.

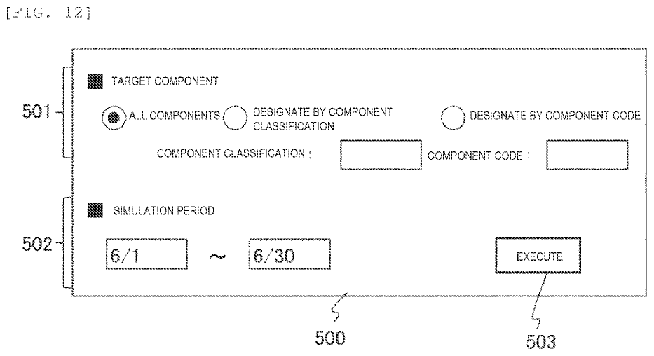

Next, FIG. 8 shows an example of the cost information 224. The cost information 224 is for managing estimated values of total costs with respect to order condition proposals of each component. The cost information 224 includes component codes, order condition proposals, and total costs.

In the case of FIG. 8, for example, it is shown that an estimated value of a total cost in an order condition proposal X001 for a component code B003 is 6400 k¥.

Next, FIG. 9 shows an example of the recommended order condition information 225. The recommended order condition information 225 is for managing recommended order conditions for which changes should be negotiated with a supplier for each component. The recommended order condition information 225 includes component codes, order conditions before change, total costs before change, order conditions after change, total costs after change, and cost reduction sums.

In the case of FIG. 9, for example, it is shown that when an order condition before change, that is, a latest order condition X002 is changed to a recommended order condition X001, a total cost turns from 6800 k¥ to 6400 k¥, producing a cost reduction sum of 400 k¥ for components of a component code B003.

Return to FIG. 1. The arithmetic unit 13 generates the output information 22 based on the input information 21 that is transferred from the storage unit 12 to a memory unit 31 and on stock information 41 (to be described below). The arithmetic unit 13 includes the memory unit 31 and an arithmetic processing unit 32.

The memory unit 31 is formed of a semiconductor memory or the like. The memory unit 31 is used as a work area for arithmetic processing by the arithmetic processing unit 32. The memory unit 31 is also used for temporarily storing the input information 21 transferred from the storage unit 12, the stock information 41 read from the stock management device 40, and the output information 22 obtained as a processing result of the arithmetic processing unit 32.

The arithmetic processing unit 32 includes functional blocks of a data acquisition unit 321, a component-based price unit change rate calculation unit 322, a classification-based unit price change rate estimation unit 323, an order condition proposal generation unit 324, a cost estimation unit 325, a recommended order condition selection unit 326, and an output control unit 327.

Each functional block of the arithmetic processing unit 32 is implemented by, for example, a Central Processor Unit (CPU) forming the arithmetic processing unit 32 that executes predetermined programs.

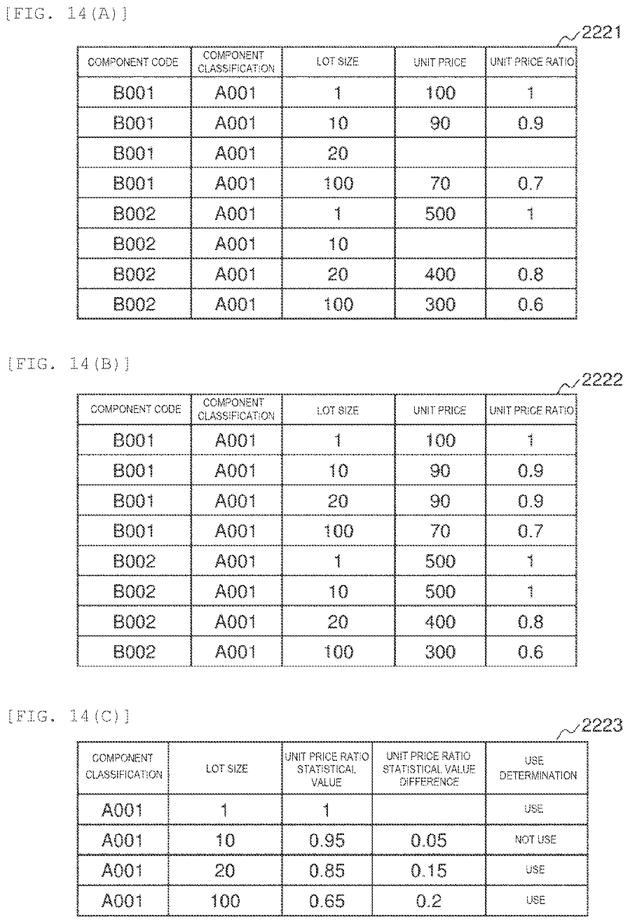

The data acquisition unit 321 acquires the input information 21 and the stock information 41 necessary for generating an order condition proposal for a target component that is designated by a user using an input screen 500 (FIG. 12), and stores the input information 21 and the stock information 41 in the memory unit 31.

The component-based unit price change rate calculation unit 322 calculates a unit price change rate based on the negotiation history information 212 (FIG. 3) when a lot size of each component is changed, generates the component-based unit price change information 221 (FIG. 5) including calculation results thereof, and stores the component-based unit price change information 221 in the memory unit 31.

The classification-based unit price change rate estimation unit 323 calculates a standard unit price change rate based on a component-based unit price change rate calculated by the component-based unit price change rate calculation unit 322 when lot sizes of components for each classification are changed, generates the classification-based unit price change information 222 (FIG. 6) including calculation results thereof, and stores the classification-based unit price change information 222 in the memory unit 31.

The order condition proposal generation unit 324 generates a plurality of order condition proposals for each component based on a component classification-based price unit change rate calculated by the classification-based unit price change rate estimation unit 323, generates the order condition proposal information 223 (FIG. 7) including the order condition proposals, and stores the order condition proposal information 223 in the memory unit 31.

The cost estimation unit 325 estimates a total cost corresponding to each of the plurality of generated order condition proposals generated by the order condition proposal generation unit 324, generates the cost information 224 (FIG. 8) including estimation results thereof, and stores the cost information 224 in the memory unit 31.

The recommended order condition selection unit 326 selects a recommended order condition from the order condition proposals based on an estimated total cost, generates the recommended order condition information 225 (FIG. 9) including a selection result thereof, and stores the recommended order condition information 225 in the memory unit 31.

The output control unit 327 controls display of various types of information in a display provided in the input and output unit 11. The output control unit 327 outputs the component-based unit price change information 221, the classification-based unit price change information 222, the order condition proposal information 223, the cost information 224, and the recommended order condition information 225, which are stored in the memory unit 31, to the storage unit 12 to be stored as the output information 22.

The communication unit 14 is connected to the stock management device 40 via a network 20 to communicate predetermined information.

The stock management device 40 includes, for example, a server and a personal computer. The stock management device 40 is connected to the component ordering device 10 via the bidirectional communication network 20 represented by the Internet. The stock management device 40 generates and stores the stock information 41 indicating a stock quantity of each component.

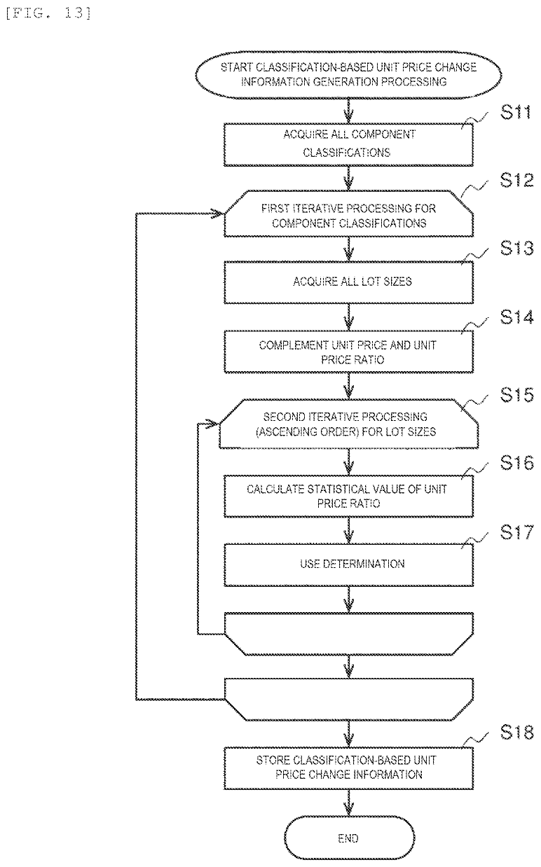

FIG. 10 shows an example of the stock information 41. The stock information 41 is for managing a current stock quantity of each component. In the case of FIG. 10, for example, it is shown that a stock quantity of components of a component code B001 is 10.

The stock information 41 may be generated by the stock management device 40, transmitted to the component ordering device 10 and stored in the storage unit 12.

Further, for example, the component ordering device 10 may be configured on a so-called cloud server to be accessed from a personal computer or the like operated by a user.

<Order Condition Recommendation Processing by Component Ordering System 1>

FIG. 11 is a flowchart illustrating an order condition recommendation processing performed by the component ordering system 1.

The order condition recommendation processing is performed before a user negotiates with a supplier. The order condition recommendation processing is started in response to, for example, the user operating an execution button 503 after designating a target component and a simulation period via the input screen 500 (FIG. 12) displayed on the input and output unit 11.

FIG. 12 shows a display example of the input screen 500. The input screen 500 includes a target component designation column 501, a simulation period designation column 502, and the execution button 503. In the target component designation column 501, a user can designate a component that is a generation target of an order condition proposal. Specifically, it is possible to designate all components, perform designation based on component classifications, or designate a target component based on a component code. In the simulation period designation column 502, the user can designate a simulation period. The execution button 503 can instruct the start of an order condition recommendation processing by a user's operation (such as clicking).

In the display example of FIG. 12, all components are designated as target components in the target component designation column 501, and 6/1 to 6/30 is designated as a simulation period in the simulation period designation column 502. Hereinafter, a case where all components are designated as the target components and 6/1 to 6/30 is designated as the simulation period, as shown in FIG. 12, will be described as an example.

First, the data acquisition unit 321 acquires corresponding input information 21 and stock information 41 based on the target components and the simulation period that are designated in the input screen 500, and stores the acquired input information 21 and stock information 41 in the memory unit 31 (step S1). Specifically, the component master information 211 (FIG. 2), the negotiation history information 212 (FIG. 3), and the component demand information 213 (FIG. 4) are acquired from the storage unit 12 as the input information 21, and the stock information 41 is acquired from the stock management device 40. Then the input information 21 and the stock information 41 are stored in the memory unit 31.

Next, the component-based unit price change rate calculation unit 322 refers to the component master information 211 (FIG. 2) in the memory unit 31, calculates unit price ratios of each lot size based on lot sizes and unit prices in the negotiation history information 212 (FIG. 3) in the memory unit 31 for components having a negotiation history, generates the component-based unit price change information 221 (FIG. 5) including calculation results thereof, and stores the component-based unit price change information 221 in the memory unit 31 (step S2).

Specifically, for example, a set including three types of lot sizes and unit prices for the component code B001 is read from the negotiation history information 212 (FIG. 3) for a component code B001 having a negotiation history in the component master information 211 (FIG. 2), and a unit price ratio for a unit price of 90 k¥ at a lot size of 10 is calculated to be 0.9 (=90/100) with a unit price of 100 k¥ at a lot size of 1 taken as reference. Similarly, a unit price ratio for a unit price 70 k¥ at a lot size of 100 is calculated to be 0.7 (=70/100).

Next, the classification-based unit price change rate estimation unit 323 estimates component classification-based unit price change rates based on the component-based unit price change information 221 (FIG. 5) stored in the memory unit 31, generates the classification-based unit price change information 222 (FIG. 6) including estimation results thereof, and stores the classification-based unit price change information 222 in the memory unit 31 (step S3).

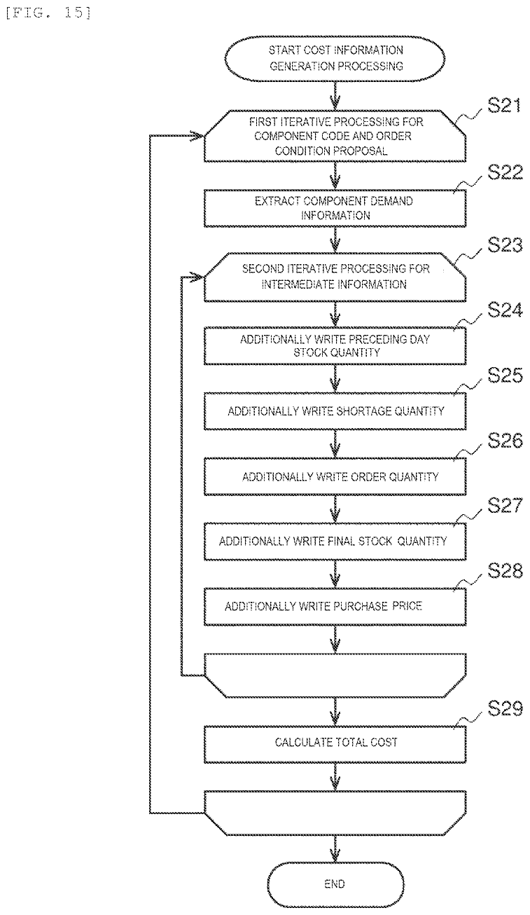

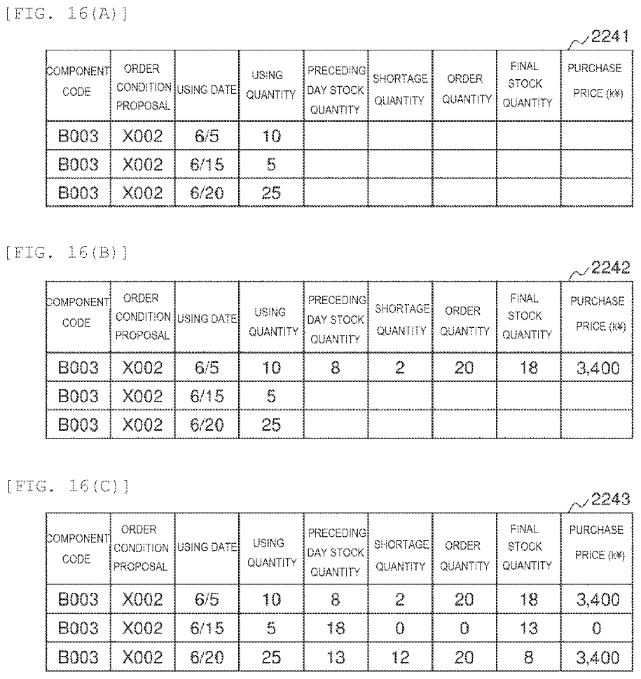

FIG. 13 is a flowchart illustrating the above-described step S3 in detail. FIGS. 14(A) to 14(C) show intermediate information generated and updated in the course of generating the classification-based unit price change information 222 (FIG. 6).

First, the classification-based unit price change rate estimation unit 323 acquires all component classifications from the component-based unit price change information 221 (FIG. 5) stored in the memory unit 31 (step S11). Next, the classification-based unit price change rate estimation unit 323 sequentially sets all acquired component classifications as processing targets, and performs a first iterative processing to be described below with respect to the component classifications of the processing targets (step S12). Hereinafter, a first iterative processing for a component classification A001 will be described as an example.

First, the classification-based unit price change rate estimation unit 323 acquires all lot sizes corresponding to the component classifications of the processing targets with reference to the component-based unit price change information 221 (FIG. 5) (step S13). In this example, 4 types of lot sizes, which are 1, 10, 20, and 100, are acquired as lot sizes corresponding to the component classification A001 from the component-based unit price change information 221 (FIG. 5).

Next, the classification-based unit price change rate estimation unit 323 adds a unit price item (column) to the component-based unit price change information 221 (FIG. 5), and adds a row such that a row corresponding to all the lot sizes acquired in step S13 exists to generate the intermediate information 2221 (FIG. 14(A)) for all component codes belonging to the component classifications of the processing targets. Further, the classification-based unit price change rate estimation unit 323 generates the intermediate information 2222 (FIG. 14(B)) by complementing blanks of unit prices and unit price ratios in the intermediate information 2221 (FIG. 14(A)) (step S14).

Specifically, the classification-based unit price change rate estimation unit 323 adds items of the unit prices to the component-based unit price change information 221 (FIG. 5), and adds a row of lot size 20 currently not present in the component code B001 and a row of lot size 10 currently not present in the component code B002 so as to generate the intermediate information 2221 (FIG. 14(A)); the component codes B001 and B002 belong to the component classification A001. Further, the classification-based unit price change rate estimation unit 323 uses a unit price and a unit price ratio of a lot size that is one size smaller than that of each of the added row to generate the intermediate information 2222 (FIG. 14(B)) in which the blanks of the intermediate information 2221 (FIG. 14(A)) are complemented.

For example, a unit price of 90 k¥ and a unit price ratio of 0.9 at a lot size of 10, which is one size smaller than the lot size of 20 of the component code B001, is used as the unit price and unit price ratio of the lot size 20 of the component code B001. For example, a unit price of 500 k¥ and a unit price ratio of 1 at a lot size of 1, which is one size smaller than the lot size of 10 of the component code B002, is used as the unit price and unit price ratio of the lot size 10 of the component code B002.

Next, the classification-based unit price change rate estimation unit 323 sets all the lot sizes acquired in step S13 as processing targets, and performs a second iterative processing thereon in ascending order (step S15).

First, the classification-based unit price change rate estimation unit 323 extracts unit price ratios of lot sizes of the processing targets from the intermediate information 2222 (FIG. 14(B)), calculates statistical values, and generates the intermediate information 2223 (FIG. 14(C)) using calculation results thereof (step S16). An average value or a median value may be adopted as a statistical value, for example. Hereinafter, a case where an average value is adopted as a statistical value will be described.

Next, the classification-based unit price change rate estimation unit 323 calculates a unit price ratio statistical value difference between a lot size (a lot size that is not used is excluded) of a processing target and a lot size one size smaller, determines whether to “use” or “not use” information of the lot size of a processing target based on whether the difference is not less than a predetermined threshold (for example, 0.1), and records determination results thereof in items (columns) of use determination of the intermediate information 2223 (step S17). Step S17 is performed to prevent a large number of order condition proposals having a small change in the unit price from being generated in the order condition proposal in step S4 to be described below.

However, a lot size of 1 is excluded from the processing targets since the unit price ratio statistical value thereof is always 1, and the second iterative processing is omitted. It is always determined to “use” information of the lot size of 1.

Specifically, the classification-based unit price change rate estimation unit 323 first takes lot sizes of 10 as processing targets, and calculates a statistical value (average value) of a unit price ratio 0.9 of the component code B001 and a unit price ratio 1 of the component code B002 to be 0.95. Next, the classification-based unit price change rate estimation unit 323 calculates a difference (unit price ratio statistical value difference) between the statistical value 0.95 and a unit price ratio statistical value 1 of a lot size of 1 which is one size smaller to be 0.05, and compares the unit price ratio statistical value difference 0.05 with a predetermined threshold 0.1. In this case, it is determined to “not use” the unit price ratio statistical value difference 0.05 since the unit price ratio statistical value difference 0.05 is smaller than the predetermined threshold 0.1. Thereafter, the processing returns to step S15.

Next, the classification-based unit price change rate estimation unit 323 takes lot sizes of 20 as processing targets, and calculates a statistical value (average value) of a unit price ratio 0.9 of the component code B001 and a unit price ratio 0.8 of the component code B002 to be 0.85. Next, the classification-based unit price change rate estimation unit 323 calculates a difference (unit price ratio statistical value difference) between the statistical value 0.85 and a unit price ratio statistical value of a lot size which is one size smaller. In this case, since it is determined to “not use” a lot size of 10 that is one size smaller, a difference (unit price ratio statistical value difference) between the statistical value 0.85 and a unit price statistical value 1 of a lot size of 1 which is one size smaller than the lot size of 10 is calculated to be 0.15. Further, the unit price ratio statistical value difference 0.15 is compared with the predetermined threshold 0.1. In this case, it is determined to “use” the unit price ratio statistical value difference 0.15 since the unit price ratio statistical value difference 0.15 is larger than the predetermined threshold 0.1. Then, the processing returns to step S15.

Next, the classification-based unit price change rate estimation unit 323 takes lot sizes of 100 as processing targets, and calculates a statistical value (average value) of a unit price ratio 0.7 of the component code B001 and a unit price ratio 0.6 of the component code B002 to be 0.65. Next, the classification-based unit price change rate estimation unit 323 calculates a difference (unit price ratio statistical value difference) between the statistical value 0.65 and the unit price ratio statistical value 0.85 of the lot size of 20 which is one size smaller to be 0.2, and compares the unit price ratio statistical value difference 0.2 with the predetermined threshold 0.1. In this case, it is determined to “use” the unit price ratio statistical value difference 0.2 since the unit price ratio statistical value difference 0.2 is larger than the predetermined threshold 0.1.

The classification-based unit price change rate estimation unit 323 returns the processing to step S12, takes subsequent component classifications as processing targets and performs the first iterative processing thereon, after the intermediate information 2223 (FIG. 14(C)) for the target component classifications is generated as described above. The processing proceeds to step S18 after the intermediate information 2223 is generated for all the component classifications acquired in step S11.

Next, the classification-based unit price change rate estimation unit 323 extracts information of rows determined to be “use” from the intermediate information 2223 for each of all the component classifications acquired in step S11, generates the classification-based unit price change information 222 (FIG. 6), and stores the classification-based unit price change information 222 in the memory unit 31 (step S18). Thus, the classification-based unit price change information generation processing (step S3 in FIG. 11) is terminated.

Return to FIG. 11. Next, the order condition proposal generation unit 324 acquires component classifications and the latest order conditions (lot sizes and unit prices) corresponding to each of the target components from the component master information 211 (FIG. 2), and acquires unit price ratio statistical values corresponding to the component classifications of the target components from the classification-based unit price change information 222 (FIG. 6). Further, the order condition proposal generation unit 324 generates the order condition proposal information 223 (FIG. 7) including an order condition proposal for each component based on the acquired information, and stores the order condition proposal information 223 in the memory unit 31 (step S4).

Specifically, for example, in a case where target components are of a component code B003, the order condition proposal generation unit 324 acquires the component classification A001 and the latest order condition (unit price of 170 k¥ at a lot size of 20) corresponding to the component code B003 from the component master information 211 (FIG. 2), acquires a unit price ratio statistical value of 0.85 of the lot size of 20 and a unit price ratio statistical value of 0.65 of a lot size of 100 corresponding to the component classification A001 from the classification-based unit price change information 222 (FIG. 6), and calculates a unit price of a lot size of 1 of the component code B003 to be 200 (=170/0.85) k¥ and a unit price of the lot size of 100 of the component code B003 to be 130 (=200×0.65) k¥ based on these pieces of information. Further, the order condition proposal generation unit 324 generates the order condition proposal information 223 (FIG. 7) as order condition proposals X001 to X003, including the latest order condition (the unit price of 170 k¥ at the lot size of 20), and stores the order condition proposal information 223 in the memory unit 31.

Next, the cost estimation unit 325 calculates total costs estimated corresponding to each order condition proposal of the order condition proposal information 223 (FIG. 7) based on the component demand information 213 (FIG. 4), the stock information 41 (FIG. 10) and the order condition proposal information 223 (FIG. 7), generates the cost information 224 (FIG. 8) including calculation results thereof, and stores the cost information 224 in the memory unit 31 (step S5).

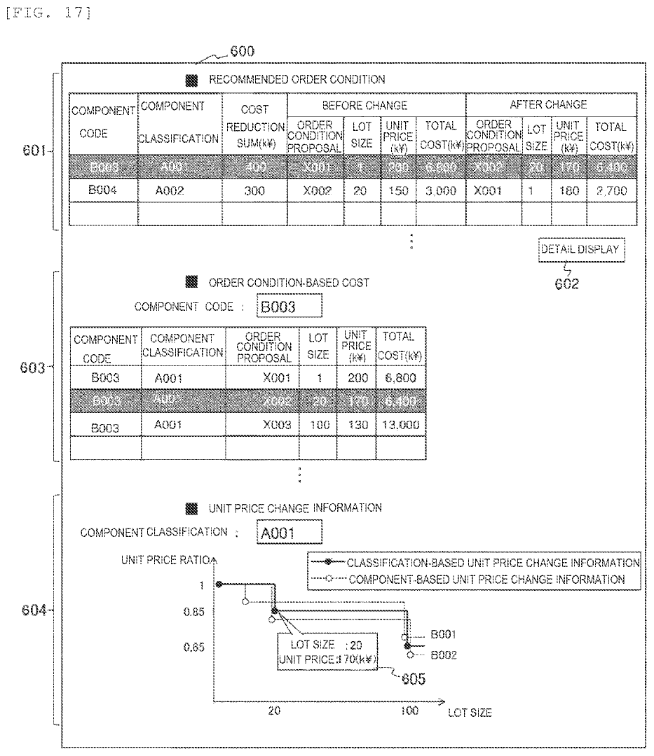

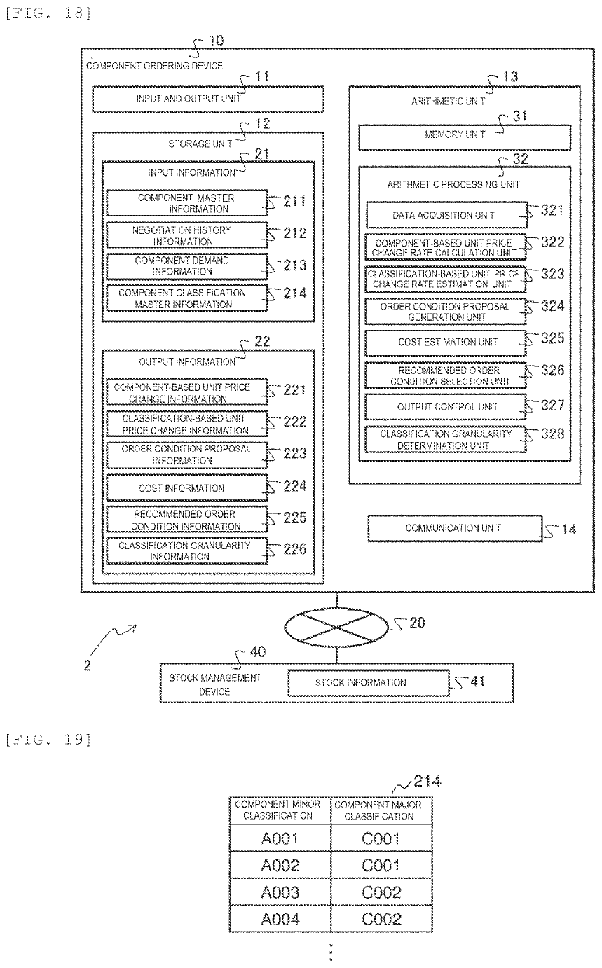

FIG. 15 is a flowchart illustrating the above-described step S5 in detail. FIGS. 16(A) to 16(C) show intermediate information generated and updated in the course of generating the cost information 224 (FIG. 8).

First, the cost estimation unit 325 refers to the order condition proposal information 223 (FIG. 7), takes each row of the order condition proposal information 223 (combination of the component code and the order condition proposal) as a processing target, and performs the first iterative processing to be described below thereon (step S21). Hereinafter, the first iterative processing for the second row (combination of the component code B003 and the order condition proposal X002 (the unit price of 170 k¥ at the lot size of 20)) of the order condition proposal information 223 (FIG. 7) will be described as an example.

First, the cost estimation unit 325 refers to the component demand information 213 (FIG. 4) stored in the memory unit 31, and extracts a using date and a using quantity of the target component in a simulation period designated by a user in the input screen 500 (FIG. 12). Hereinafter, the target component is the component code B003 and the simulation period thereof is set to 6/1 to 6/30. In this case, a using quantity of a using date of 6/3 is 10, a using quantity of a using date of 6/15 is 5, and a using quantity of a using date of 6/20 is 25. Further, the cost estimation unit 325 uses the extracted using dates and using quantities to generate the intermediate information 2241 as shown in FIG. 16(A) (step S22). At this stage, the items of a preceding day stock quantity, a shortage quantity, an order quantity, a final stock quantity, and a purchase price in each row of the intermediate information 2241 are blanks.

Next, the cost estimation unit 325 takes each row of the intermediate information 2241 (FIG. 16(A)) as a processing target and performs the second iterative processing sequentially thereon (step S23). Hereinafter, the second iterative processing in the case where the first row (the using date of 6/5, the using quantity of 10) of the intermediate information 2241 (FIG. 16(A)) is taken as a processing target row will be described.

First, the cost estimation unit 325 additionally writes a preceding day stock quantity of a using date of a target row (step S24). That is, the stock quantity at the starting time of work of the using date, which is the stock quantity at the end of work of a preceding day to the using date, is additionally written. Specifically, the stock quantity corresponding to the component code of the stock information 41 (FIG. 10) is used as the preceding day stock quantity when the using date in the processing target row is the earliest using date in the component demand information 213 (FIG. 4). When the using date in the processing target row is not the earliest using date in the component demand information 213 (FIG. 4), the final stock quantity of the preceding using date is used.

In this example, since the using date (6/5) in the processing target row is the earliest using date in the component demand information 213 (FIG. 4), the stock quantity (8) corresponding to a component code B003 of the stock information 41 (FIG. 10) is used and additionally written as in the intermediate information 2242 (FIG. 16(B)).

Next, the cost estimation unit 325 calculates and additionally writes a shortage quantity based on a using quantity on a using date in a processing target row and a preceding day stock quantity (step S25). Here, the shortage quantity is a value of shortage between the using quantity on the using date in the processing target row and the preceding day stock quantity. When the using quantity is larger than the preceding day stock quantity, the difference value (the using quantity−the preceding stock number) is additionally written. On the contrary, 0 is additionally written since there is no shortage when the using quantity is not more than the preceding day stock quantity. In this example, a shortage quantity of 2 is additionally written to a shortage quantity column of the intermediate information 2242 (FIG. 16(B)) since the using quantity of the using date (6/5) in the processing target row is 10 and the preceding day stock quantity is 8.

Next, the cost estimation unit 325 calculates and additionally writes an order quantity based on the shortage quantity of the using date of the processing target row and a lot size in an order condition proposal (step S26). Specifically, the order quantity is 0 when the shortage quantity is 0. The shortage quantity is compared with the lot size of the order condition proposal, and a value of the larger one is determined to be the order quantity and is additionally written, when the shortage quantity is not 0. In this example, since the shortage quantity is 2 and the lot size of an order condition proposal X002 is 20, the cost estimation unit 325 determines 20 of the larger one to be the order quantity and additionally writes the order quantity to the order quantity column of the intermediate information 2242 (FIG. 16(B)).

Next, the cost estimation unit 325 calculates and additionally writes the final stock quantity based on the using quantity of the using date in processing target row, the preceding day stock quantity and the order quantity (step S27). In other words, the final stock quantity is a stock quantity after reception of ordered components and delivery of components to be used on the using date are all completed, which can be calculated using the preceding day stock quantity+the order quantity−the using quantity. The final stock quantity 18 (=8+20−10) is additionally written to the final stock quantity column of the intermediate information 2242 (FIG. 16(B)) since the using quantity of the using date 6/5 in the processing target row is 10, the preceding day stock quantity is 8, and the order quantity is 20.

Next, the cost estimation unit 325 calculates and additionally writes a purchase price on the using date in the processing target row based on the order quantity and a unit price of the order condition proposal (step S28). In this example, the purchase price 3400 (=20×170) k¥ is additionally written to the purchase price column of the intermediate information 2242 (FIG. 16(B)) since the order quantity of the using date 6/5 in the processing target row is 20 and the unit price is 170 k¥.

As described above, after all the items on the using date in the processing target row of the intermediate information 2241 (FIG. 16(A)) are filled, the next row of the intermediate information 2241 is taken as a processing target and the first iterative processing is performed thereon. After the intermediate information 2243 (FIG. 16(C)) is obtained by taking all rows of the intermediate information 2241 as processing targets and performing the first iterative processing thereon, the cost estimation unit 325 calculates a total cost by adding up the purchase prices of the intermediate information 2243 (step S29). In this example, a total cost of the order condition proposal X002 for the component code B003 is calculated to be 6800 (=3400+3400) k¥.

As described above, the cost estimation unit 325 returns the processing to step S21 and performs the first iterative processing on other combinations after the total cost for the combination of the component code and the order condition proposal is calculated. After the cost estimation unit 325 calculates total costs for all combinations of the component codes and the order condition proposals recorded in the order condition proposal information 223, the cost information 224 (FIG. 8) is generated using the calculated total costs and is stored in the memory unit 31. Thus, the purchase cost calculation processing (step S5 in FIG. 11) is terminated.

Return to FIG. 11. Next, the recommended order condition selection unit 326 selects an order condition proposal having a minimum total cost from the generated order conditions as a recommended order condition for each component code based on the component master information 211 (FIG. 2), the order condition proposal information 223 (FIG. 7) and the cost information 224 (FIG. 8), calculates a cost reduction sum (difference in total cost before and after changes) in the case of changing from the latest order condition to the recommended order condition, generates the recommended order condition information 225 including a result thereof and stores the recommended order condition information 225 in the memory unit 31 (step S6).

Specifically, for the component code B003, for example, the recommended order condition selection unit 326 acquires a current order condition (a unit price 170 k¥ at a lot size of 20) from the component master information 211 (FIG. 2), and recognizes that the latest order condition from the order condition proposal information 223 (FIG. 7) is the order condition proposal X002. Next, the recommended order condition selection unit 326 selects an order condition proposal X001 whose total cost is minimum (6400 k¥) from the cost information 224 (FIG. 8) as the recommended order condition, calculates a difference (400K k¥) from a total cost (6800 k¥) of the order condition proposal X002 that is the latest order condition, and generates the recommended order condition information 225.

The recommended order condition information 225 shown in FIG. 9 indicates that an order condition proposal X001 is selected as the recommended order condition for the component code B003, the order condition proposal X002 is selected as the recommended order condition for a component code B004, and an order condition proposal X004 is selected as the recommended order condition for a component code B005.

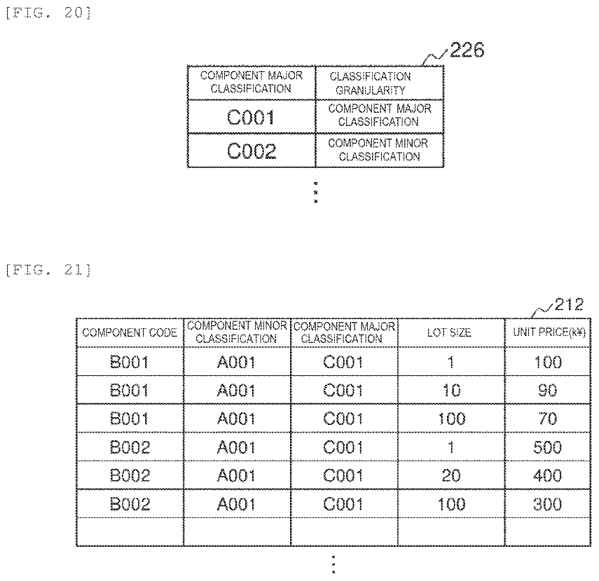

Finally, the component-based unit price change information 221, the classification-based unit price change information 222, the order condition proposal information 223, the cost information 224 and the recommended order condition information 225, all of which are stored in the memory unit 31, are output to the storage unit 12 and stored as the output information 22, by the output control unit 327. Further, the output control unit 327 generates an output screen 600 (FIG. 17) based on the component-based unit price change information 221, the classification-based unit price change information 222, the order condition proposal information 223, the cost information 224 and the recommended order condition information 225, and displays the output screen 600 on a display of the input and output unit 11 (step S7). Thus, the order condition recommendation processing by the component ordering system 1 is terminated.

FIG. 17 shows a display example of the output screen 600 displayed by the above-described order condition recommendation processing. The output screen 600 includes a recommended order condition display 601 and a detail display button 602.

The recommended order condition display 601 displays the recommended order condition information 225 (FIG. 9) in a tabular form, and recommended order conditions for each component code can be rearranged in a predetermined sequence and displayed.

In the display example of FIG. 17, the recommended order conditions for each component code are arranged in ascending order of the cost reduction sum. Accordingly, the user can easily grasp a component having a great merit (great reduction sum in total cost) when an order condition is changed.

The detail display button 602 is operated (clicking or the like) after a user selects a random row in the recommended order condition display 601, so that an order condition proposal-based cost display 603 and a unit price change information display 604, which correspond to a component code in the selected row, can be displayed under the recommended order condition display 601.

The order condition proposal-based cost display 603 displays a component classification, an order condition proposal, a lot size, a unit price and a total cost in a tabular form, all of which correspond to the component code in the selected row and are extracted from the order condition proposal information 223 (FIG. 7) and the cost information 224 (FIG. 8).

In the display example of FIG. 17, a case is indicated where the user selects a row of a component code B003 in the recommended order condition display 601, and a plurality of order condition proposals X001 to X003 (including a recommended order condition X002) corresponding to the component code B003 are displayed in the order condition proposal-based cost display 603.

The unit price change information display 604 displays information in a graph form, which corresponds to the component code and the component classification in the selected row and which is extracted from the component-based unit price change information 221 (FIG. 5) and the classification-based unit price change information 222 (FIG. 6). The unit price change information display 604 can indicate where the order condition proposal of the row selected by the user in the order condition proposal-based cost display 603 corresponds to the unit price change that is displayed graphically.

In the display example of FIG. 17, the order condition proposal X002 in the second row is selected in the order condition proposal-based cost display 603, and a balloon 605 including the lot size and the unit price is displayed at a position corresponding to the order proposal X002 in the graph of the unit price change information display 604.

By checking the output screen 600, the user can grasp for which component negotiating with the supplier over order condition change has the best cost reduction effect.

The total cost is calculated only in consideration of the purchase price in the above description. However, a total cost including the stock management cost may be calculated and information regarding the stock management cost per hour or per piece may also be managed for each component, for example.

Further, for the component, information on warehouse occupancy volume per piece and on capacity of a storage destination warehouse may also be managed, and a combination of order condition proposals which minimizes the total cost may be selected while a total of occupancy volumes of the components in each storage destination warehouse does not exceed the capacity thereof.

As described above, according to the first embodiment of the invention, since an order condition proposal is generated by estimating a unit price change rate of a component in the case of changing a lot size, based on an order condition established in the past for components belonging to the same component classification, an order condition proposal that is possible to be accepted by the supplier for each component can be generated. Further, an order condition proposal having a large total cost reduction sum among the generated order condition proposals is taken as a recommended order condition. Since recommended order conditions for a plurality of components are presented to the user at the same time, the user can specify a component to be preferentially negotiated with the supplier over order condition change from among the plurality of recommended order conditions so that the total cost can be reduced.

<Configuration Example of Component Ordering System According to Second Embodiment of Invention>

In the first embodiment described above, the unit price change rate in the case of changing the lot size is estimated for each single component classification to which each component belongs, and an order condition proposal is generated. Each component may belong to a component classification having a hierarchical structure.

For example, a certain metallic component may belong to a major classification of a metal plate, and may also belong to minor classifications such as an aluminum plate and a copper plate, which belong to the major classification. As described above, when a certain component belongs to a plurality of component classifications having different granularity, if estimation of the unit price change rate or generation of the order condition proposal is performed using a classification having coarse granularity (major classification) as the component classification, there is a merit that the number of samples serving as bases of the estimation can be increased. However, due to the increase in the number of samples, there is a demerit that components having completely different unit price change tendency are mixed in samples serving as bases for estimating the unit price change rate.

Therefore, in the second embodiment to be described below, in addition to the similar processing as in the first embodiment, the unit price change rate is estimated by changing the granularity of the component classification to which each component belongs and estimation errors of unit price ratio corresponding to the component classifications having different granularity are compared, so that the granularity of the component classifications to be used can be determined. In the description below, a hierarchy of 2 in which a component minor classification is under a component major classification is mentioned as a hierarchy of component classification, and a case where the hierarchy of component classification is 3 or more may be considered in the same manner.

FIG. 18 shows a configuration example of a component ordering system 2 according to the second embodiment of the invention. In the component ordering system 2, component classification master information 214 is added to the input information 21, classification granularity information 226 is added to the output information 22, and a classification granularity determination unit 328 is added to the arithmetic processing unit 32, with respect to the component ordering system 1 (FIG. 1) according to the first embodiment of the invention. Constituent elements of the component ordering system 2 common to those of the component ordering system 1 are denoted by the same reference numerals, and descriptions thereof will be omitted as appropriate.

The component classification in the second embodiment has a two-layer hierarchical structure including a component major classification and a component minor classification. The component minor classification corresponds to the component classification in the first embodiment.

The component classification master information 214 indicates a hierarchical structure of component classifications to which each component belongs.

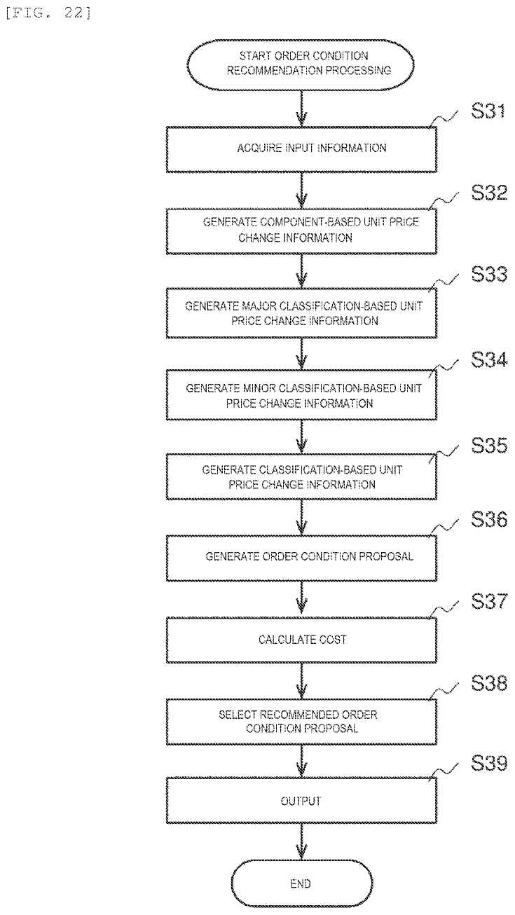

FIG. 19 shows an example of the component classification master information 214. In the case of FIG. 19, it is shown that component minor classifications A001 and A002 belong to a component major classification C001, and that component minor classifications A003 and A004 belong to a component major classification C002.

The classification granularity information 226 indicates component classification of which granularity is used for each component classification (in this case, component major classification) of the highest hierarchy to estimate a unit price change rate and to generate an order condition proposal.

FIG. 20 shows an example of the classification granularity information 226. In the case of FIG. 20, it is shown that, for the component major classification C001, the unit price change rate is estimated and the order condition proposal is generated for each component major classification, and for the component major classification C002, the unit price change rate is estimated and the order condition proposal is generated for each component minor classification.

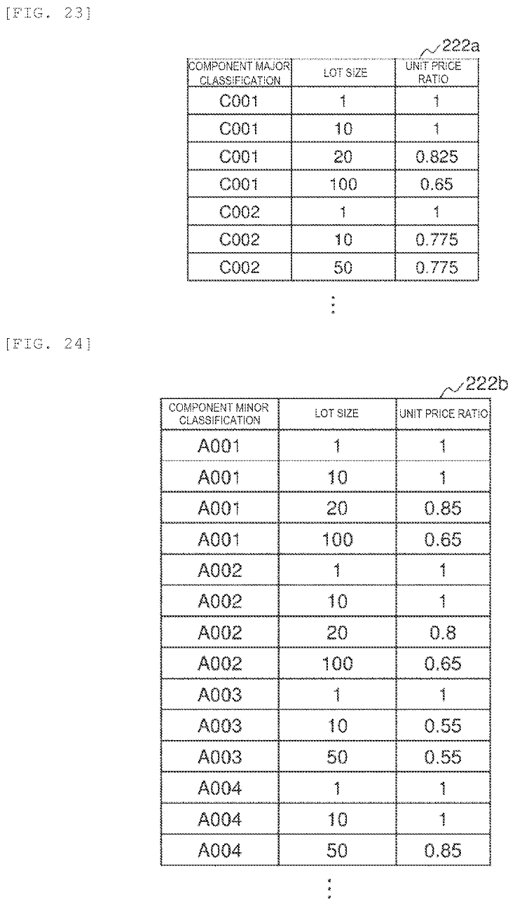

Next, FIG. 21 shows an example of the negotiation history information 212 in the second embodiment. The negotiation history information 212 is obtained by adding the item (column) of the component major classification to the negotiation history information 212 (FIG. 3) of the first embodiment.

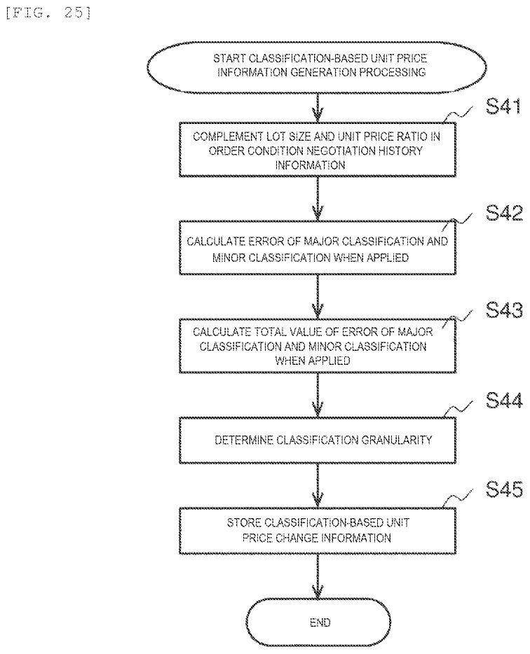

Return to FIG. 18. The classification-based unit price change rate estimation unit 323 in the component ordering system 2 generates major classification-based unit price change information 222a (FIG. 23) and minor classification-based unit price change information 222b (FIG. 24), and stores the major classification-based unit price change information 222a and the minor classification-based unit price change information 222b in the memory unit 31.

The classification granularity determination unit 328 generates the above-described classification granularity information 226 (FIG. 20) and stores the classification granularity information 226 in the memory unit 31 (to be described in detail below). The classification granularity determination unit 328 generates the classification-based unit price change information 222, based on the major classification-based unit price change information 222a (FIG. 23) and the minor classification-based unit price change information 222b (FIG. 24) that are generated by the classification-based unit price change rate estimation unit 323 and on the classification granularity information 226 (FIG. 20), and stores the classification-based unit price change information 222 in the memory unit 31. The major classification-based unit price change information 222a and the minor classification-based unit price change information 222b correspond to per-hierarchy classification-based unit price change information of the invention.

<Order Condition Recommendation Processing by Component Ordering System 2>

FIG. 22 is a flowchart illustrating an order condition recommendation processing performed by the component ordering system 2.

The order condition recommendation processing is performed before a user negotiates with a supplier, similar to the order condition recommendation processing (FIG. 11) by the component ordering system 1. The order condition recommendation processing is started in response to, for example, the user operating the execution button 503 after designating a target component and a simulation period via the input screen 500 (FIG. 12) displayed on the input and output unit 11.

Hereinafter, a case where all components are designated as the target components and 6/1 to 6/30 is designated as the simulation period, as shown in FIG. 12, will be described as an example.

First, the data acquisition unit 321 acquires the corresponding input information 21 and the corresponding stock information 41 based on the target components and the simulation period that are designated by the user in the input screen 500, and stores the input information 21 and the stock information 41 in the memory unit 31 (step S31). Specifically, the component master information 211, the negotiation history information 212, the component demand information 213 and the component classification master information 214 are acquired from the storage unit 12 as the input information 21, and the stock information 41 is acquired from the stock management device 40. Then the input information 21 and the stock information 41 are stored in the memory unit 31.

Next, the component-based unit price change rate calculation unit 322 refers to the component master information 211 (FIG. 2) in the memory unit 31, calculates unit price ratios of each lot size based on lot sizes and unit prices in the negotiation history information 212 (FIG. 3) in the memory unit 31 for components having a negotiation history, generates the component-based unit price change information 221 (FIG. 5) including calculation results thereof, and stores the component-based unit price change information 221 in the memory unit 31 (step S32). Since step S32 is the same as step S1 in FIG. 11, a detailed description thereof will be omitted.

Next, the classification-based unit price change rate estimation unit 323 estimates component major classification-based unit price change rates based on the component-based unit price change information 221 (FIG. 5) stored in the memory unit 31, generates the major classification-based unit price change information 222a (FIG. 23) including estimation results thereof, and stores the major classification-based unit price change information 222a in the memory unit 31 (step S33).

Next, the classification-based unit price change rate estimation unit 323 estimates component minor classification-based unit price change rates based on the component-based unit price change information 221 (FIG. 5) stored in the memory unit 31, generates the minor classification-based unit price change information 222b (FIG. 24) including estimation results thereof, and stores the minor classification-based unit price change information 222b in the memory unit 31 (step S34).

Since steps S33 and S34 are the same as step S3 in FIG. 11, a detailed description thereof will be omitted.

Next, the classification granularity determination unit 328 determines the granularity of the component classification to be used for each component major classification, based on the major classification-based unit price change information 222a (FIG. 23) generated in step S33 and the minor classification-based unit price change information 222b (FIG. 24) generated in step S34. The classification-based unit price change rate estimation unit 323 generates the classification-based unit price change information 222 (FIG. 6) according to the determined granularity of the component classification (step S35).

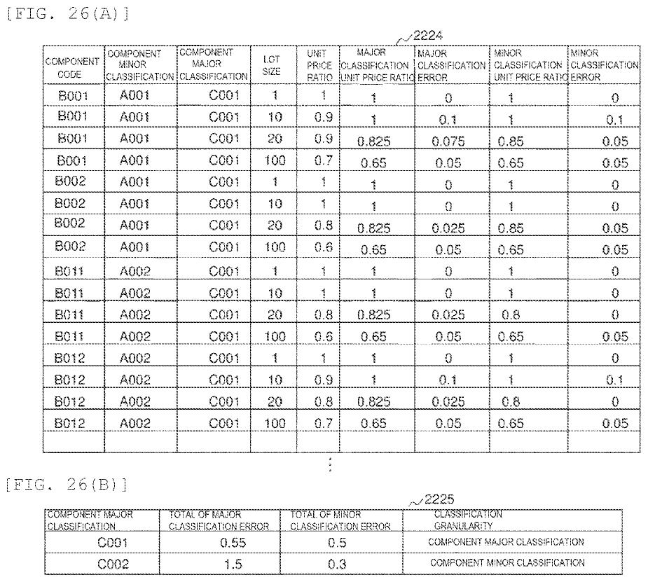

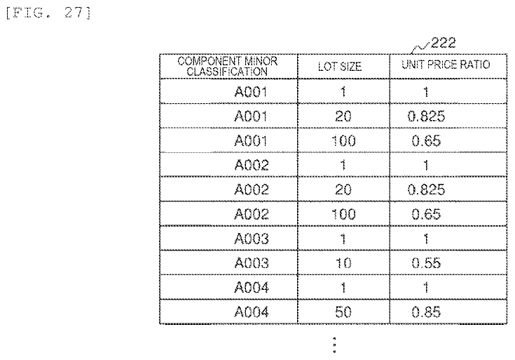

FIG. 25 is a flowchart illustrating the above-described classification-based unit price change information generation processing in step S35 in detail. FIGS. 26(A) and 26(B) show intermediate information generated and updated in the course of generating the classification-based unit price change information 222 (FIG. 6).

First, the classification granularity determination unit 328 acquires all corresponding lot sizes from the negotiation history information 212 (FIG. 21) for each component major classification, adds a row for each component code of the negotiation history information 212 (FIG. 21) so that rows corresponding to all acquired lot sizes are present, and, as step S14 in FIG. 13, generates the intermediate information 2224 shown in FIG. 26(A) by complementing unit price ratios (step S41).

Specifically, in this case, lot sizes of 1, 10, 20, and 100 are acquired from the negotiation history information 212 (FIG. 21) as all the lot sizes corresponding to a component major classification C001. For example, a row of the lot size of 20 is added to a component code B001. However, at this stage, columns of a major classification unit price ratio, a major classification error, a minor classification unit price ratio and a minor classification error in the intermediate information 2224 are blanks.

Next, the classification granularity determination unit 328 uses the major classification-based unit price change information 222a (FIG. 23) and the minor classification-based unit price change information 222b (FIG. 24) to complement the blanks of the major classification unit price ratio and the minor classification unit price ratio in the intermediate information 2224, and further calculates errors thereof with actual unit price ratios of each component to complement the blanks of the major classification error and the minor classification error (step S42).

Specifically, in this case, unit price ratios of the first row to the fourth row in the major classification-based unit price change information 222a (FIG. 23) are used as the major classification-based unit price ratios of the first row to the fourth row in the intermediate information 2224 (FIG. 26(A)), and unit price ratios of the first row to the fourth row in the minor classification-based unit price change information 222b (FIG. 24) are used as the minor classification-based unit price ratios of the first row to the fourth row in the intermediate information 2224 (FIG. 26(A)). Further, for example, for the third row in the intermediate information 2224, an error between a unit price ratio of 0.9 and a major classification unit price ratio of 0.825 is calculated to be 0.075 and complemented as a major classification error, and an error between a unit price ratio of 0.9 and a minor classification unit price ratio of 0.85 is calculated to be 0.05 and complemented as a minor classification error.

Next, the classification granularity determination unit 328 calculates a total value of the major classification errors and a total value of the minor classification errors, for each component major classification, and generates intermediate information 2225 (FIG. 26(B)) using calculation results thereof (step S43). In this case, the total value of the major classification errors is calculated to be 0.55 and the total value of the minor classification errors is calculated to be 0.5 for the component major classification C001 based on the intermediate information 2224 (FIG. 26(A)).

Next, the classification granularity determination unit 328 compares a ratio of the total value of the major classification errors with respect to the total value of the minor classification errors with a predetermined reference value, determines the classification granularity of the component major classification based on the comparison result thereof, and generates the classification granularity information 226 (FIG. 20) based on the determination result thereof (step S44).

For example, the classification granularity determination unit 328 determines the classification component granularity of the component major classification as a component minor classification, when the ratio of the total value of the major classification errors with respect to the total value of the minor classification errors (the total value of the minor classification errors/the total value of the major classification errors) is not less than the reference value (for example, 2). On the contrary, the classification granularity determination unit 328 determines the classification granularity of the component major classification as a component major classification when the ratio is less than the reference value.

In the case of the intermediate information 2225 shown in FIG. 26(B), the classification granularity determination unit 328 determines the classification granularity as a component major classification since the ratio 1.1 (=0.55/0.5) for a component major classification C001 is less than a reference value 2. The classification granularity determination unit 328 determines the classification granularity as a component minor classification since the ratio 5 (=1.5/0.3) for a component major classification C002 is not less than the reference value 2. The classification granularity determination unit 328 generates the classification granularity information 226 (FIG. 20) based on the determined classification granularity for each component major classification, and stores the classification granularity information 226 in the memory unit 31.

Next, the classification granularity determination unit 328 generates the classification-based unit price change information 222 (FIG. 27) based on the component classification master information 214 (FIG. 19), the major classification-based unit price change information 222a (FIG. 23), the minor classification-based unit price change information 222b (FIG. 24) and the classification granularity information 226 (FIG. 20), and stores the classification-based unit price change information 222 in the memory unit 31 (step S45).

Specifically, for example, it is understood based on the classification granularity information 226 (FIG. 20) that the classification granularity of the component major classification C001 is a component major classification, and it is understood based on the component classification master information 214 (FIG. 19) that the component minor classifications A001 and A002 belong to the component major classification C001. Therefore, the classification granularity determination unit 328 uses the information of the component major classification C001 in the major classification-based unit price change information 222a (FIG. 23) for lot sizes and unit prices of the component minor classifications A001 and A002 in the classification-based unit price change information 222 (FIG. 27).

For example, it is understood based on the classification granularity information 226 (FIG. 20) that the classification granularity of the component major classification C002 is a component minor classification, and it is understood based on the component classification master information 214 (FIG. 19) that the component minor classifications A003 and A004 belong to the component major classification C002. Therefore, the classification granularity determination unit 328 uses the information of component minor classifications A003 and A004 in the minor classification-based unit price change information 222b (FIG. 24) for lot sizes and unit prices of the component minor classifications A003 and A004 in the classification-based unit price change information 222 (FIG. 27).

Thus, the classification-based unit price change information generation processing (step S35 in FIG. 22) is terminated. Return to FIG. 22. Next, steps S36 to S39 are executed. Since steps S36 to S39 are the same as steps S4 to S7 in FIG. 11, descriptions thereof will be omitted.

As described above, according to the order condition recommendation processing by the component ordering system 2, it is possible to generate an order condition proposal for each component which is easily accepted by the supplier and to estimate the cost reduction sum even when components having different unit price change tendencies are mixed in the same major component classification, since the granularity of the component classification used in estimating unit price change can be changed in the case where the component classification has a hierarchical structure. Therefore, the user can specify a component to be preferentially negotiated with the supplier over order condition change from among multiple components, so that the total cost can be reduced.

The embodiments of the invention have been described above, but the invention is not limited to an example of the embodiments described above and includes various modifications. For example, an example of the embodiments described above has been described in detail in order to make the invention easy to understand, and the invention is not limited to including all the configurations described herein. Apart of a configuration of an example in a certain embodiment can be replaced with a configuration of another example. A configuration of another example can be added to a configuration of an example of a certain embodiment. Another configuration may be added to, deleted from, or replaced with a part of a configuration of an example in each embodiment. Apart or all of the configurations described above, functions, processing units, processing means, and the like may be realized by hardware, for example, through designing an integrated circuit. Control lines and information lines shown in the figures are considered to be necessary for description, and all the lines are not necessarily shown. It may be considered that almost all configurations are connected to each other.

### REFERENCE SIGN LIST

1 Component ordering system, 2 component ordering system, 10 component ordering device, 20 bidirectional communication network, 11 input and output unit, 12 storage unit, 13 arithmetic unit, 21 input information, 22 output information, 31 memory unit, 32 arithmetic processing unit, 14 communication unit, 40 stock management device, 41 stock information, 211 component master information, 212 negotiation history information, 213 component demand information, 214 component classification master information, 221 component-based unit price change information, 222 classification-based unit price change information, 222a major classification-based unit price change information, 222b minor classification-based unit price change information, 223 order condition proposal information, 224 cost information, 225 recommended order condition information, 226 classification granularity information, 321 data acquisition unit, 322 component-based unit price change rate calculation unit, 323 classification-based unit price change rate estimation unit, 324 order condition proposal generation unit, 325 cost estimation unit, 326 recommended order condition selection unit, 327 output control unit, 328 classification granularity determination unit, 500 input screen, 501 target component designation column, 502 simulation period designation column, 503 execution button, 600 output screen, 601 recommended order condition display, 602 detail display button, 603 order condition proposal-based cost display, 604 unit price change information display, 2221 intermediate information, 2222 intermediate information, 2223 intermediate information, 2224 intermediate information, 2225 intermediate information, 2241 intermediate information, 2242 intermediate information, 2243 intermediate information

1. A component ordering device, comprising:
an order condition proposal generation unit that generates a plurality of order condition proposals when negotiating with a supplier for a component to be procured, based on negotiation history information that is established by negotiating with the supplier in past for another component belonging to the same component classification with the component to be procured, the negotiation history information including an order condition provided with a lot size and a unit price; and
an output control unit that outputs the plurality of generated order condition proposals.

2. The component ordering device according to claim 1, further comprising:
a classification-based unit price change rate estimation unit that estimates, based on the negotiation history information, a unit price change rate corresponding to the component classification to which the component to be procured belongs in a case where the lot size is changed, and that generates classification-based unit price change information including an estimation result, wherein
the order condition proposal generation unit generates the plurality of order condition based on the classification-based unit price change information.

3. The component ordering device according to claim 1, further comprising:
a cost estimation unit that estimates a total cost for each of the plurality of generated order condition proposals; and
a recommended order condition selection unit that selects, based on the estimated total cost, a recommended order condition that is possible to be accepted by the supplier from among the plurality of order condition proposals, wherein
the output control unit outputs the selected recommended order condition.

4. The component ordering device according to claim 3, wherein
the recommended order condition selection unit generates recommended order condition information including a reduction sum of the total cost in a case where a current order condition of the component to be procured is changed to the recommended order condition, and
the output control unit outputs the generated recommended order condition information.

5. The component ordering device according to claim 2, further comprising:
a classification granularity determination unit that determines, for each of the component classification in a highest hierarchy, whether to adopt per-hierarchy classification-based unit price change information corresponding to any hierarchy when the order condition proposals of the component to be procured are generated, wherein
the component to be procured belongs to the component classification that has a hierarchical structure, and
the classification-based unit price change rate estimation unit estimates, based on the negotiation history information, the unit price change rate in a case where the lot size is changed for the component classification of each hierarchy to which the component to be procured belongs, and generates the per-hierarchy classification-based unit price change information including an estimation result.

6. A component ordering method by a component ordering device, the method comprising:
generating a plurality of order condition proposals when negotiating with a supplier for a component to be procured, based on negotiation history information that is established by negotiating with the supplier in past for another component belonging to the same component classification with the component to be procured, the negotiation history information including an order condition provided with a lot size and a unit price; and
outputting the plurality of generated order condition proposals.
